(19) United States
(12) Patent Application Publication
(10) Pub. No.: US 2019/0016613 A1
(43) Pub. Date: Jan. 17, 2019

(54) SYSTEM AND METHOD OF IONIZING A FLUID

(71) Applicant: Plasma Environmental LLC, Bayside, WI (US)

(72) Inventor: Paul Goudy, Bayside, WI (US)

(21) Appl. No.: 15/650,007

(22) Filed: Jul. 14, 2017

(51) Int. Cl. C02F 1/461; C02F 1/74

(52) U.S. Cl. CPC C02F 1/4618; C02F 2201/004; C02F 2201/46135; C02F 1/74

(57) ABSTRACT

An ionization system configured to ionize a fluid. The system includes a surface area, a conductive portion, and a voltage drop element. The surface area is configured to generate friction in response to a flow of the fluid across the surface area. The conductive portion is coupled to the surface area. The conductive portion is positioned proximate the flow of fluid. The voltage drop element is coupled to the conductive portion and is configured to provide a voltage drop to the conductive portion.

### FIELD

Embodiments relate to ionizing, or partially ionizing, oxygen.

### SUMMARY

Ionized, or partially ionized, oxygen provides numerous benefits in a wide variety of fields, including but not limited to, automotive, water filtration, and medical. Known systems and methods of ionizing oxygen require large amounts of energy, which can not only be costly, but also dangerous to a user.

Thus, in one embodiment, the application provides an ionization system configured to ionize a fluid. The system includes a surface area, a conductive portion, and a voltage drop element. The surface area is configured to generate friction in response to a flow of the fluid across the surface area. The conductive portion is coupled to the surface area. The conductive portion is positioned proximate the flow of fluid. The voltage drop element is coupled to the conductive portion and is configured to provide a voltage drop to the conductive portion.

In another embodiment, the application provides a method of ionizing a fluid including receiving a flow of fluid across a surface area to generate friction, and ionizing the fluid. The method further includes collecting, via a conductive material positioned at the end of the flow of fluid, a charge, and providing a voltage drop.

In another embodiment, the application provides a system including a scrubbing device and a charge remover. The scrubbing device is configured to remove a charge from an oxygen element of a flow of fluid. The charge remover is configured to remove the charge from the scrubbing device.

In yet another embodiment, the application provides voltage drop apparatus including a housing, an electrical input, a conductive element, and a fan. The housing has a first end and a second end. The electrical input is configured to receive a charge. The conductive element is located within the housing. The conductive element is coupled to the electrical input. The fan is located proximate the first end of the housing. The fan is configured to provide a flow of fluid across the conductive element. Wherein the flow of fluid across the conductive element dissipates the charge into the atmosphere at the second end.

Other aspects of the application will become apparent by consideration of the detailed description and accompanying drawings.

### BRIEF DESCRIPTION OF THE DRAWINGS

FIG. 1 is a block diagram illustrating an ionization system according to some embodiments.

FIG. 2 is a block diagram illustrating an ionizer of the ionization system of FIG. 1 according to some embodiments.

FIG. 3A is a perspective view of an ionizer of the ionization system of FIG. 1 according to some embodiments.

FIG. 3B is a block diagram of the ionizer of FIG. 3A according to some embodiments.

FIG. 3C is a perspective view of an ionizer of the ionization system of FIG. 1 according to some embodiments.

FIG. 4A is a cross-section view of an ionizer of the ionization system of FIG. 1 according to some embodiments.

FIG. 4B is a partial perspective view of the ionizer of FIG. 4A according to some embodiments.

FIG. 5 is a perspective view of an ionizer of the ionization system of FIG. 1 according to some embodiments.

FIG. 6 is a cross-section view of the ionizer of FIG. 5 according to some embodiments.

FIG. 7 is a perspective view of an ionizer of the ionization system of FIG. 1 according to some embodiments.

FIG. 8 is a cross-section of a portion of the ionizer of FIG. 7 according to some embodiments.

FIG. 9 is a perspective view of an ionizer of the ionization system of FIG. 1 according to some embodiments.

FIG. 10A is a block diagram of an electron dispersing element according to some embodiments.

FIGS. 10B & 10C are perspective view of the electron dispersing element of FIG. 10A.

FIG. 11 is a cross-section view of the ionizer of FIG. 5 according to another embodiment.

FIG. 12 is a perspective view of an electron dispersing element according to another embodiment.

FIG. 13 is a perspective view of a conductive unit of the electron dispersing element of FIG. 12 according to some embodiments.

FIG. 14 is a perspective view of an electron dispersing element according to another embodiment.

FIG. 15 is a top view of a vehicle according to some embodiments.

FIG. 16 is a block diagram of a water filtration system according to some embodiments.

FIG. 17 is a flow chart illustrating a process of the ionization system of FIG. 1 according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

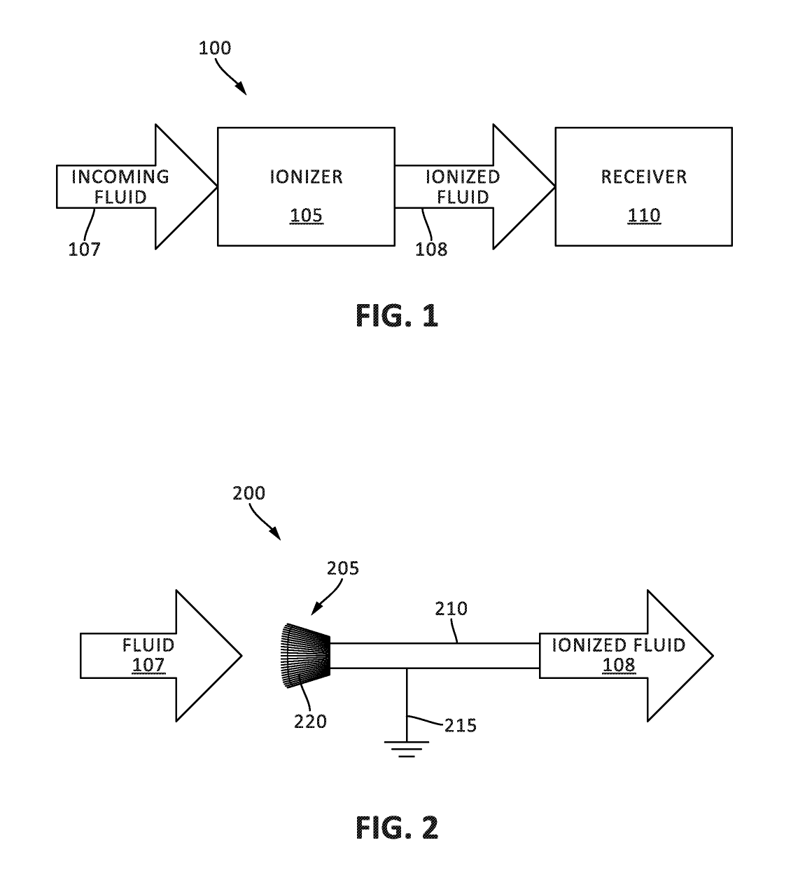

FIG. 1 is a block diagram illustrating a system 100 according to some embodiments. The system 100 includes an ionizer 105 and a receiver 110. The ionizer 105 is configured to ionize, or partially ionize, a fluid. More particularly, the ionizer 105 receives an incoming fluid 107 and produces an ionized fluid 108. The ionized fluid 108 from the ionizer 105 is then directed to the receiver 110. The receiver 110 may be any system, device, and/or apparatus configured to receive the ionized fluid. For example, but not limited to, the receiver 110 may be an internal combustion engine (for example, gasoline engine, diesel engine, etc.), a water filtration system, or various medical device (for example, respirators, continuous positive airway pressure (CPAP) machines, etc.).

In some embodiments, the incoming fluid 107 is air. Air, for example, at Earth's surface includes approximately 78% nitrogen, approximately 21% oxygen, and less than approximately 1% argon, carbon dioxide, and other gases. In some embodiments, the ionizer 105 receives the air and may remove an electron from one or more molecules of the air, resulting in ionized, or partially ionized, air. In some embodiments, the ionizer 105 may partially ionize the air by, for example, removing an electron from a majority of oxygen elements of the air, while an electron from one or more nitrogen molecules may remain intact. In other words, the oxygen molecules are ionized, while the nitrogen molecules may not be ionized. In some embodiments, as discussed in more detail, the oxygen electron is removed via static electricity. The ionized air may then be directed to the receiver 110.

FIG. 2 illustrates an ionizer 200 according to some embodiments. Ionizer 200 may be, or may be included in, ionizer 105 in the above described system 100. Ionizer 200 includes a non-conductive portion 205, a conductive portion 210, and a ground, or grounding element 215. The non-conductive portion 205 may include a surface area 220. In the illustrated embodiment, the non-conductive portion 205 includes a plurality of bristles or wires. The plurality of bristles or wires may be formed of a non-conductive material, such as but not limited to, nylon. The exterior surfaces of the bristles or wires form the surface areas 220.

The conductive portion 210 is coupled to the non-conductive portion 205. The conductive portion 210 may be formed of a conductive material (for example, copper, copper mesh, stainless steel, galvanized steel, zinc-plated steel, zinc, or aluminum). In some embodiments, the conductive portion 210 may include a plurality of bristles or wires. In such an embodiment, the bristles or wires may be formed of a conductive material (for example, copper, copper mesh, stainless steel, galvanized steel, zinc-plated steel, zinc, or aluminum). In some embodiments, the conductive portion 210 may be configured to hold the non-conductive portion 205 in place. For example, the non-conductive portion 205 may be physically coupled to an input portion of the conductive portion 210. The grounding element 215 is electrically coupled to the conductive portion 210. In some embodiment, the grounding element 215 is configured to electrically ground the ionizer 200. In other embodiments, the grounding element 215 is configured to provide a voltage drop.

In operation, an incoming fluid 107 flows over the surface area 220 of the non-conductive portion 205. As the fluid flows over the surface area 220, friction is produced as a result of the fluid flowing over the surface area 220. The produced friction results in static electricity. The static electricity partially ionizes the fluid flowing over the surface area 220. In some embodiments, partially ionizing the fluid includes ionizing (i.e., removing at least one electron of) one or more oxygen molecules of the fluid, while the nitrogen molecules of the fluid are not ionized. The conductive portion 210, which in some embodiments is positioned at the end of a flow of the fluid, collects the removed electrons of the one or more oxygen molecules, while the partially ionized fluid passes through and is delivered to a receiver 110. The collected electrons (i.e., charge) may then be removed, or drained, via the ground element 215.

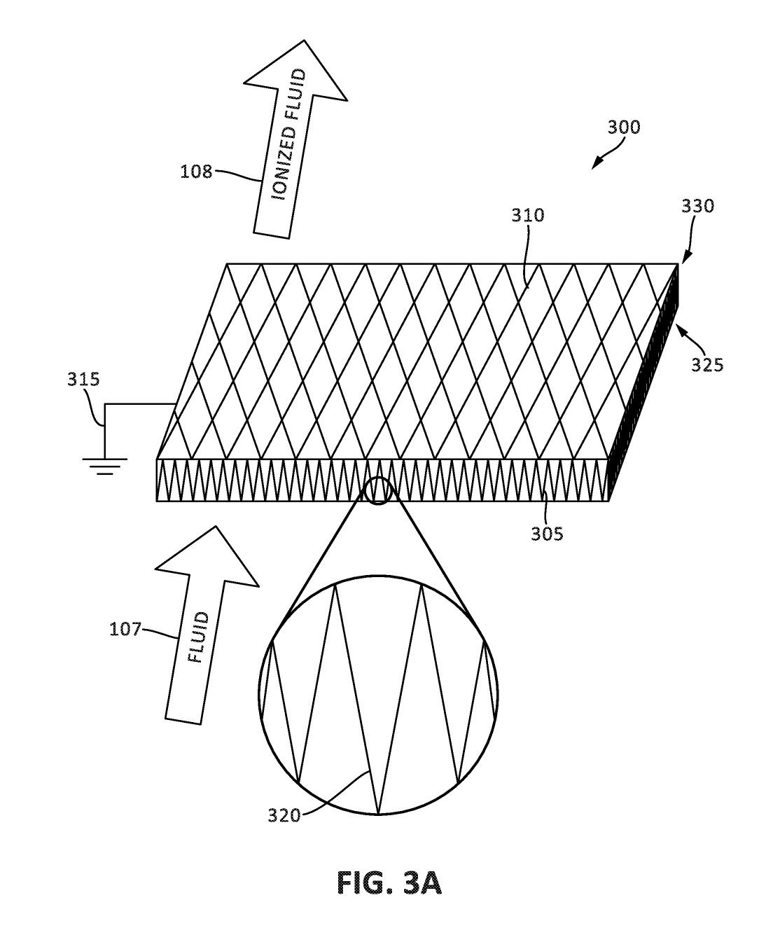

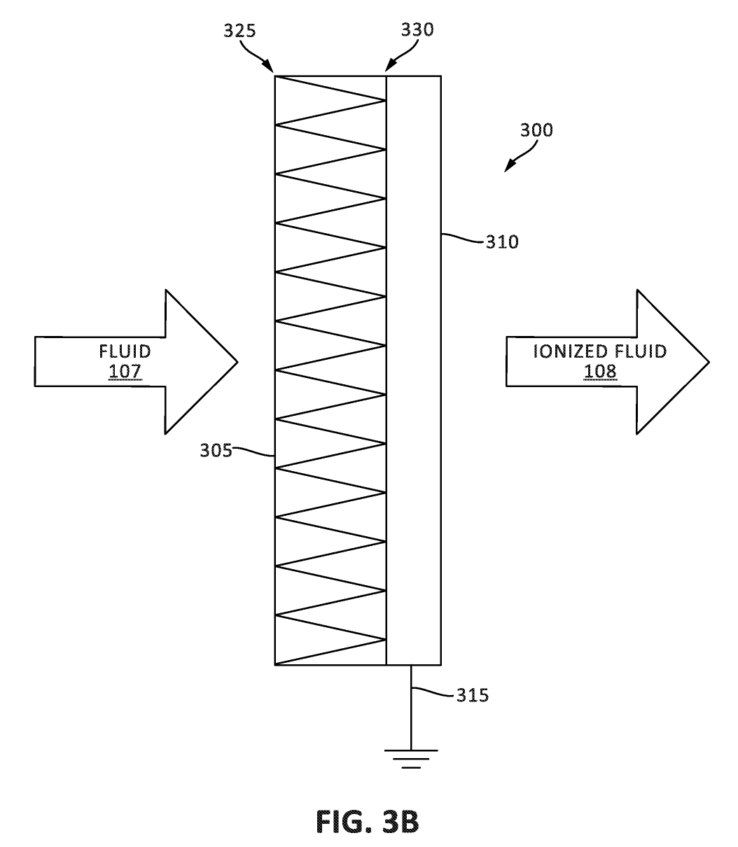

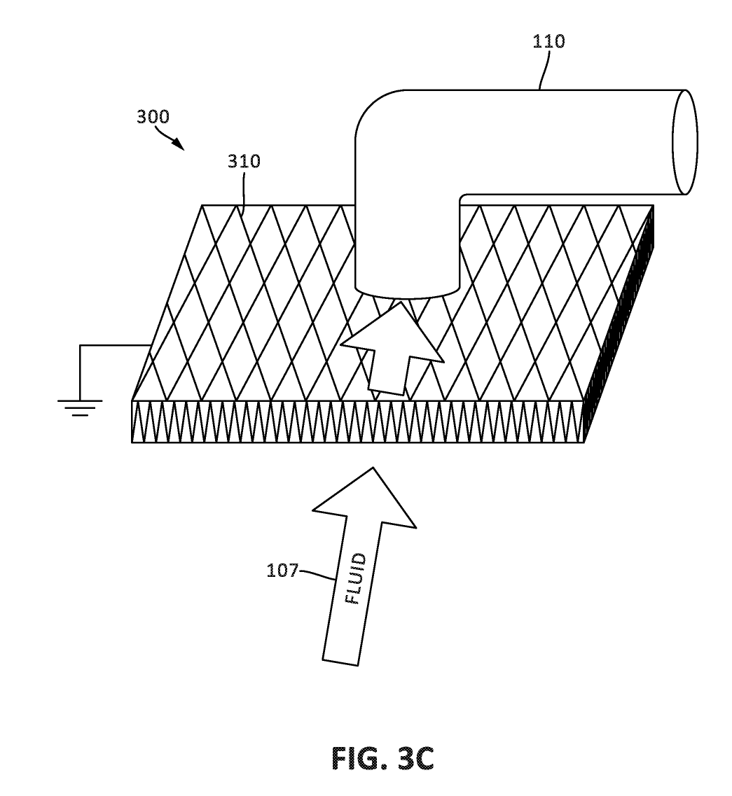

FIGS. 3A-3C illustrate an ionizer 300 according to some embodiments. Ionizer 300 may be, or may be included in, ionizer 105 in the above described system 100. Ionizer 300 includes a non-conductive portion 305, a conductive portion 310, and a ground, or grounding element 315.

As illustrated, non-conductive portion 305 includes a surface area 320, a first side 325, and a second side 330. In the illustrated embodiment, the non-conductive portion 305 is formed of a paper, or paper-like material (for example, nylon, fiberglass, etc.). In some embodiments, the non-conductive portion 305 includes an air filter. In the illustrated embodiment, the surface area 320 includes a plurality of ridges or grooves. The plurality of ridges or grooves provides a relatively large surface area of non-conductive material over which the fluid passes over relative to the area of the first side 325 and second side 330.

The conductive portion 310 is coupled to the second side 330 of the non-conductive portion 305. In some embodiments, the conductive portion 310 is a conductive grid formed of a conductive material (for example, stainless steel, galvanized steel, zinc-plated steel, zinc, or aluminum). In such an embodiment, the conductive portion 310 may overlay the second side 330. The grounding element 315 is electrically coupled to the conductive portion 310. In some embodiment, the grounding element 315 is configured to electrically ground the ionizer 300. In other embodiments, the grounding element 315 is configured to provide a voltage drop.

In operation, the fluid 107 flows into the first side 325, from the first side 325 to the second side 330 over the surface area 320, and exits the second side 330. As the fluid 107 flows over surface area 320, friction is created resulting in static electricity. The static electricity partially ionizes the fluid flowing from the first side 325 to the second side 330. In some embodiments, partially ionizing the fluid includes ionizing (i.e., removing an electron of) one or more oxygen molecules of the fluid, while the nitrogen molecules of the fluid are not ionized. The conductive portion 310, which in some embodiments is positioned at the end of a flow of the fluid, collects the removed electrons of the one or more oxygen molecules, while the partially ionized fluid passes through and is delivered to a receiver 110. The collected electrons (i.e., charge) may then be removed, or drained, via the ground element 315.

As illustrated in FIG. 3C, in some embodiments, a receiver 110 may be placed proximate the conductive portion 310. In such an embodiment, the receiver 110 is configured to receive a portion of ionized fluid 108 from a relatively small area (for example, approximately 5% to approximately 20%) of the second side 330.

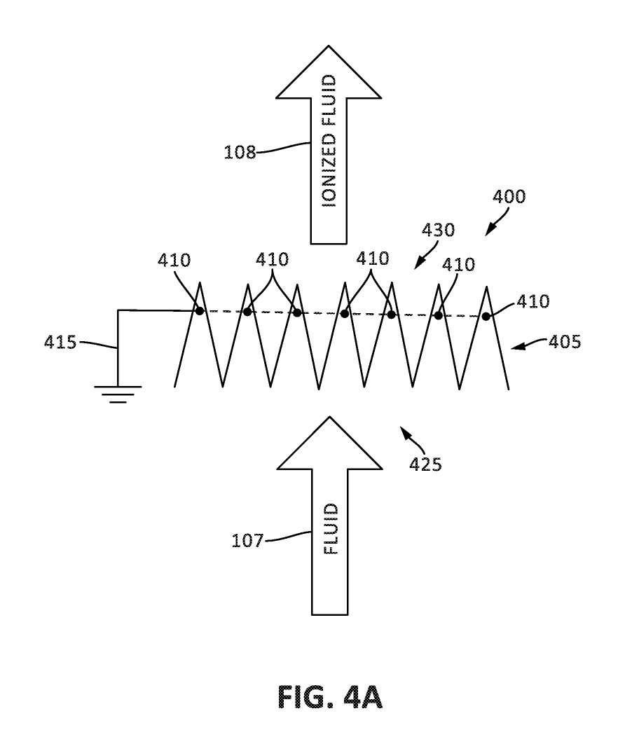

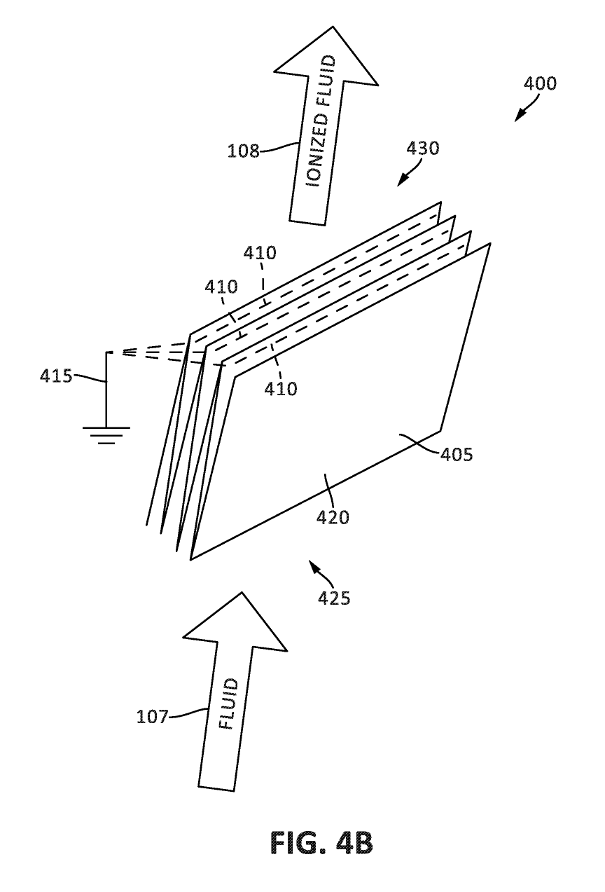

FIGS. 4A and 4B is an enlarged view illustrating an ionizer 400 according to some embodiments. Ionizer 400 may be, or may be included in, ionizer 105 in the above described system 100. Ionizer 400 includes a non-conductive portion 405, a conductive portion 410, and a ground, or grounding element 415.

As illustrated, non-conductive portion 405 includes a surface area 420, a first side 425, and a second side 430. In the illustrated embodiment, the non-conductive portion 405 is formed of a paper, or paper-like material (for example, nylon, fiberglass, etc.). In some embodiments, the non-conductive portion 405 includes an air filter. In the illustrated embodiment, the surface area 420 includes a plurality of ridges or grooves. The plurality of ridges or grooves provides a relatively large surface area of non-conductive material which the fluid may pass over. Although only illustrated as having approximately seven ridges or grooves, in other embodiments, non-conductive portion 405 may include several hundred ridges or grooves.

The conductive portion 410 is coupled to the second side 430 of the non-conductive portion 405. In the illustrated embodiment, the conductive portion 410 includes a plurality of conductive wires. In such an embodiment, the plurality of conductive wires may run parallel with the plurality of ridges or grooves of the non-conductive portion 405. Additionally, in such an embodiment, the plurality of conductive wires may be located proximate the second side 430 of the non-conductive portion 405. In some embodiments, the conductive portion 410, and thus the plurality of conductive wires, are formed of a conductive material (for example, stainless steel, galvanized steel, zinc-plated steel, zinc, or aluminum). The grounding element 415 is electrically coupled to the conductive portion 410. In some embodiments, the grounding element 415 is configured to electrically ground the ionizer 400. In other embodiments, the grounding element 415 is configured to provide a voltage drop.

In operation, the fluid 107 flows into the first side 425, from the first side 425 to the second side 430 over the surface area 420, and exits the second side 430. As the fluid flows over surface area 420, friction is created resulting in static electricity. The static electricity partially ionizes the fluid flowing from the first side 425 to the second side 430. In some embodiments, partially ionizing the fluid includes ionizing (i.e., removing an electron of) one or more oxygen molecules of the fluid, while the nitrogen molecules of the fluid are not ionized. The conductive portion 410, which in some embodiments is positioned at the end of a flow of the fluid, collects the removed electrons of the one or more oxygen molecules, while the partially ionized fluid passes through and is delivered to a receiver 110. The collected electrons (i.e., charge) may then be removed, or drained, via the ground element 415.

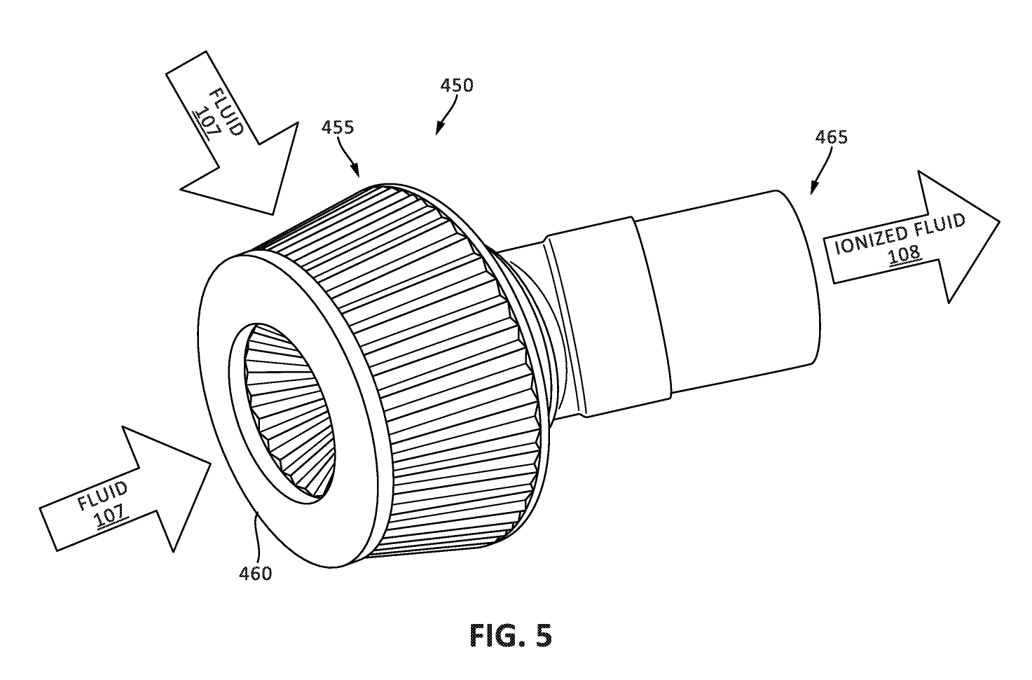

FIGS. 5 & 6 illustrate an ionizer 450 according to another embodiment. Ionizer 450 may be, or may be included in, ionizer 105 in the above described system 100. Ionizer 450 includes an exterior receiving portion 455, an interior receiving portion 460, and an output 465.

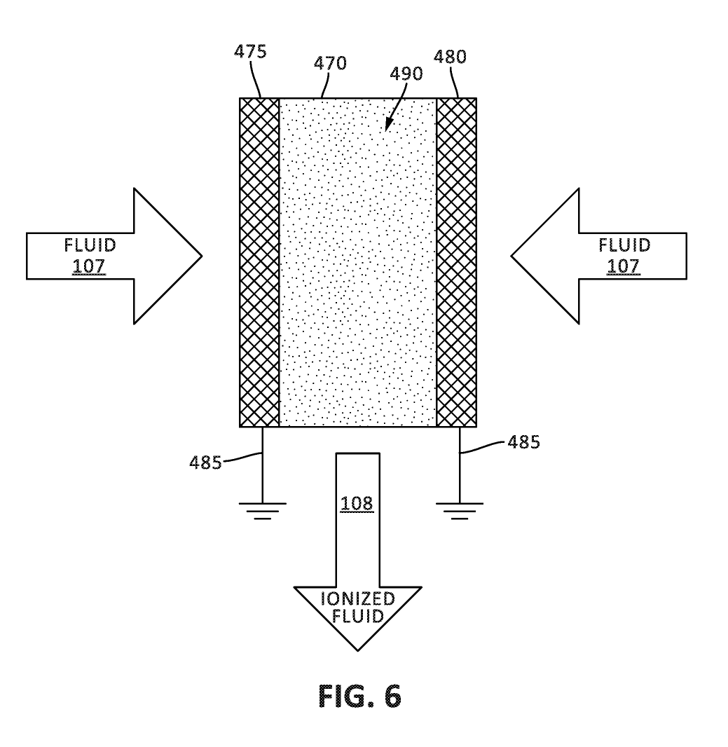

FIG. 6 illustrates a cutaway side view of ionizer 450. As illustrated, ionizer 450 further includes a non-conductive portion 470, a first conductive portion 475, a second conductive portion 480, and one or more ground, or grounding elements 485. In the illustrated embodiment, the first conductive portion 475 is located on an exterior portion of the exterior receiving portion 455 while the second conductive portion 480 is located on an exterior portion of the interior receiving portion.

Additionally, in the illustrated embodiment, the non-conductive portion 470 is located proximate, and between, the first and second conductive portions 475, 480. The non-conductive portion 470 may further include a surface area 490. The surface area 490 may include a plurality of ridges or grooves. The plurality of ridges or grooves provides a relatively large surface area of non-conductive material which the fluid may pass over.

In operation, the fluid 107 flows into the exterior receiving portion 455 and the interior receiving portion 460 and passes over the surface area 490. As the fluid flows over the surface area 490, friction is created resulting in static electricity. The static electricity partially ionizes the fluid flowing over the surface area 490. In some embodiments, partially ionizing the fluid includes ionizing (i.e., removing an electron of) one or more oxygen molecules of the fluid, while the nitrogen molecules of the fluid are not ionized. The first and second conductive portions 475, 480, which are positioned proximate the non-conductive portion 470, collect the removed electrons of the one or more oxygen molecules, while the partially ionized fluid passes through and is delivered to a receiver 110. The collected electrons (i.e., charge) may then be removed, or drained, via the one or more ground elements 485.

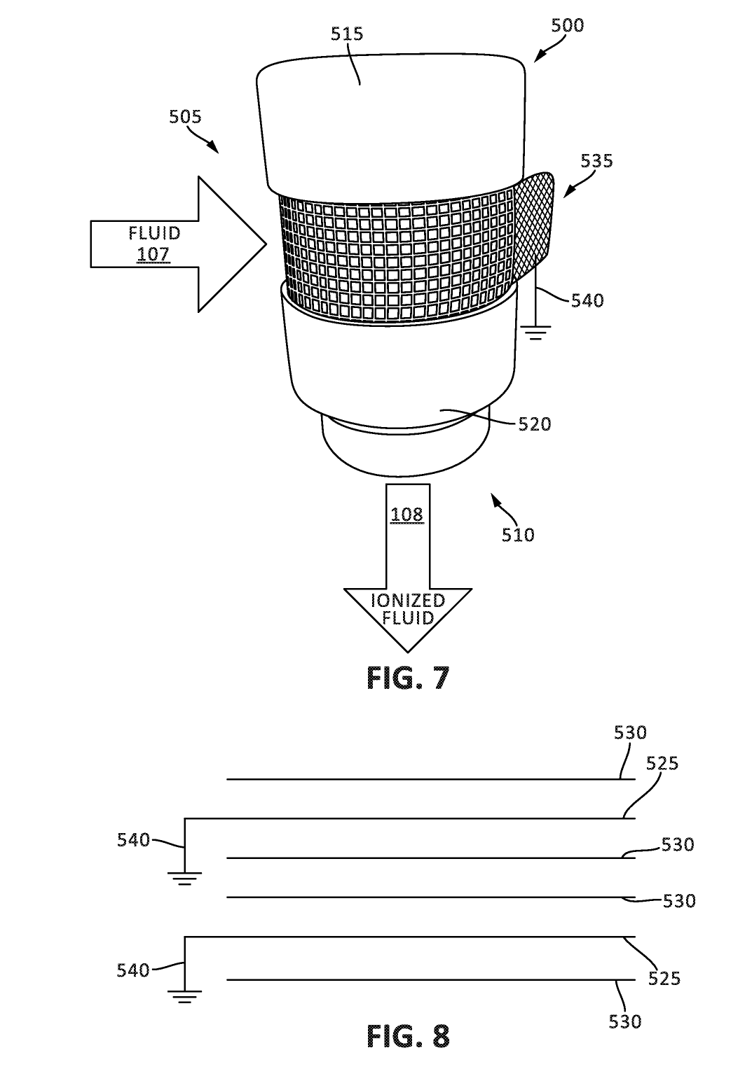

FIG. 7 illustrates an ionizer 500 according to another embodiment. Ionizer 500 may be, or may be included in, ionizer 105 in the above described system 100. Ionizer 500 includes a receiving portion 505 and an output 510. Ionizer 500 further includes a first housing portion 515 and a second housing portion 520 configured to house one or more conductive portions 525 (FIG. 8) and one or more non-conductive portions 530 (FIG. 8). Ionizer 500 further includes a tab 535. In some embodiments, the tab 535 is formed of a portion of the one or more conductive portions 525. In other embodiments, the tab 535 is formed of a different conductive material. Tab 535 is configured to provide an electrical connection between the tone or more conductive portions 525 and a grounding element 540.

FIG. 8 illustrates a side view of the one or more conductive portions 525 and one or more non-conductive portions 530 of the ionizer 500. The one or more non-conductive portions 530 include surface areas 545. As illustrated, the one or more conductive portions 525 and the one or more non-conductive portions 530 are layered. In other embodiments, the one or more conductive portions 525 and the one or more non-conductive portions 530 may be layered in a different configuration. In the illustrated embodiment of FIG. 7, the layered conductive portions 525 and non-conductive portions 530 are then rolled and housed between the first and second housing portions 515, 520.

In operation, the fluid 107 flows into the receiving portion 505 and passes over surface areas 545. As the fluid flows over the surface areas 545, friction is created resulting in static electricity. The static electricity partially ionizes the fluid flowing over the surface area 545. In some embodiments, partially ionizing the fluid includes ionizing (i.e., removing an electron of) one or more oxygen molecules of the fluid, while the nitrogen molecules of the fluid are not ionized. The layers of conductive portions 525, which are layered between the non-conductive portions 530, collect the removed electrons of the one or more oxygen molecules, while the partially ionized fluid is output via output 510. In some embodiments, the partially ionized fluid is output to the receiver 110. The collected electrons (i.e., charge) may then be removed, or drained, via the tab 535 and ground element 540.

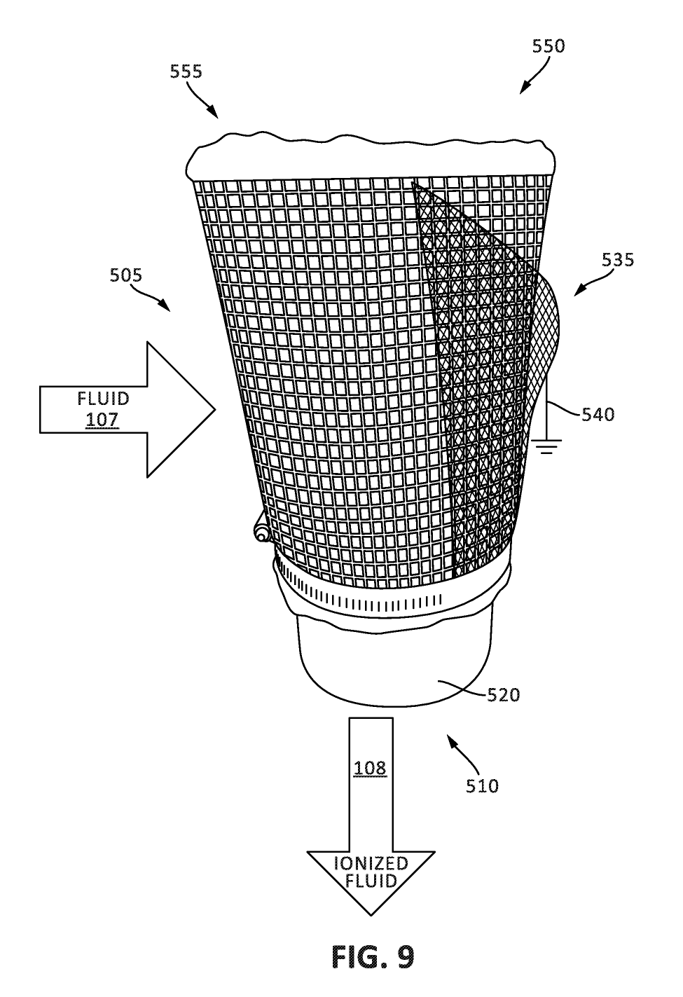

FIG. 9 illustrates an ionizer 550 according to another embodiment. In some embodiments, ionizer 550 includes substantially similar components as ionizer 500. In the illustrated embodiment, rather than having a first housing portion 515, ionizer 550 includes a seal 555. The seal 555 is configured to seal an upper portion of the layered conductive portions 525 and non-conductive portions 530.

In some embodiments, the system 100 includes a scrubbing device configured to remove a charge from an oxygen element of a fluid 107. In some embodiments, the scrubbing device is ionizer 200, 300, 400, 450, 500, 550. In some embodiments, the fluid 107 flows through the scrubbing device when the charge from the oxygen element is removed.

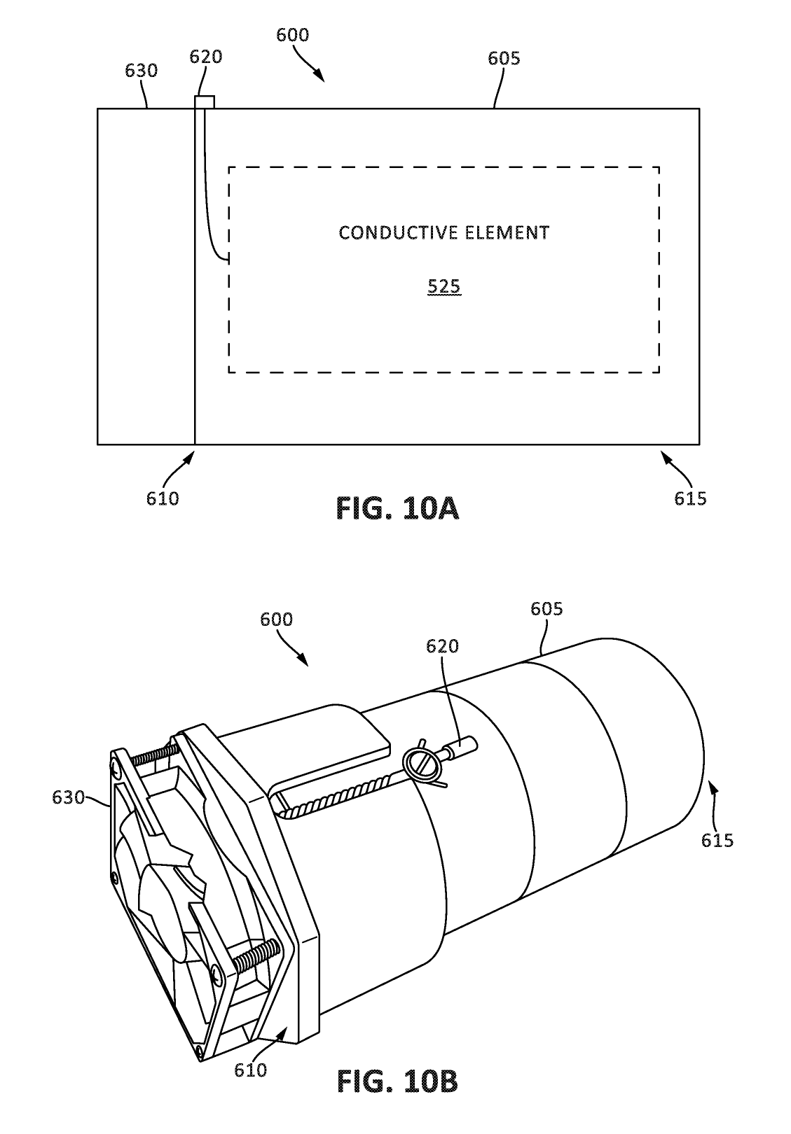

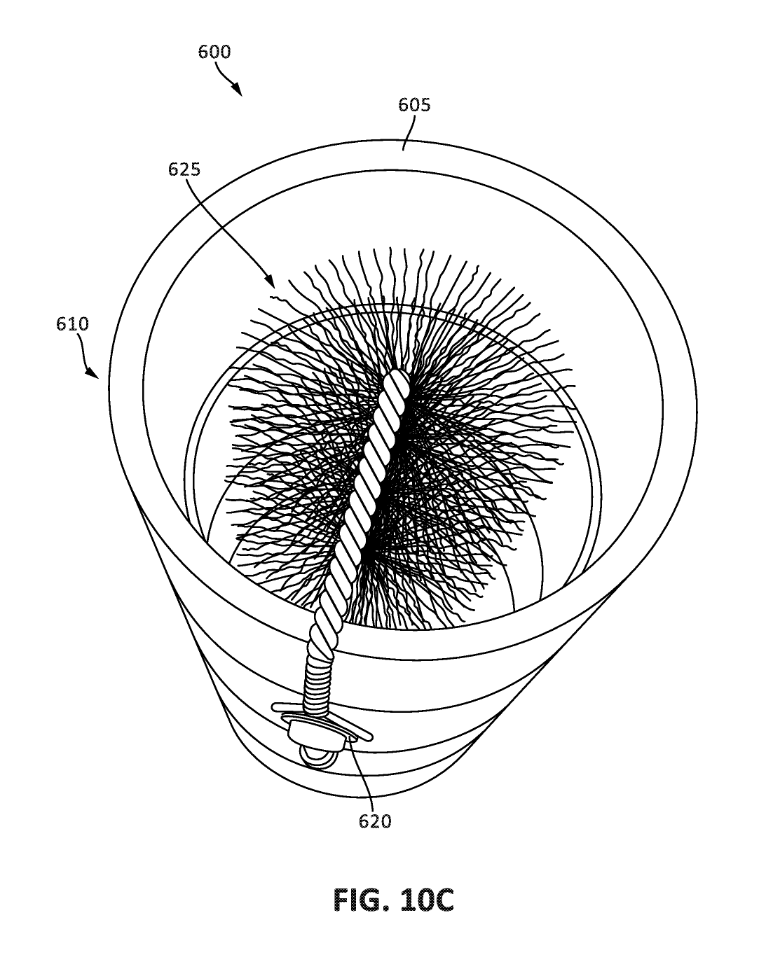

FIGS. 10A-10C illustrate an electron dispersing element 600 according to some embodiments. Electron dispersing element 600 may be, or may be included in, grounding elements 215, 315, 415, 485, and/or 540. The electron dispersing element 600 is configured to provide electrical grounding, or provide a voltage drop, to the ionizer 105. In some embodiments, electron dispersing element 600 is configured to provide a voltage drop. In some embodiments, the electron dispersing element 600 provides essentially a natural earth ground to the ionizer 105.

Electron dispersing element 600 may include a housing 605 having a first end, or inlet, 610 and a second end, or outlet, 615. The housing 605 may be formed of a non-conductive material (for example, a plastic, including but not limited to, polyvinylchloride (PVC)). The electron dispersing element 600 may further include a connection 620. In the illustrated embodiment, connection 620 is located on an exterior of the housing 605. Connection 620 may be an electrical connection configured to receive electrical energy. For example, connection 620 may provide an electrical connection between a conductive portion and the electron dispersing element 600.

Electron dispersing element 600 may further include a conductive element 525 electrically coupled to connection 620 and contained within housing 605. The conductive element 625 is configured to receive a charge from the connection 620 and dissipate the charge into the atmosphere. The conductive element 625 may be formed from a copper material, a copper mesh materials, a steel with zinc coating material, or any other conductive material. As illustrated in FIG. 10C, in some embodiments, the conductive element 625 may be a brush including a plurality of conductive bristles. In such an embodiment, the charge collects on the plurality of bristles to be discharged via a flow of fluid (for example, a flow of fluid from fan 630).

As illustrated, in some embodiments, the fan 630 may be located at the first end, or inlet, 610 of the housing 605. The fan 630 is configured to provide a flow of fluid over the conductive element 625 (for example, in some embodiments, over the plurality of bristles). As fluid flows over the conductive element 625, the charge collected by the conductive element 625 may be dissipated into the atmosphere via the second end, or outlet, 515. In some embodiments, fan 630 is a low-voltage (for example, twelve volts) direct-current fan. In another embodiment, fan 630 may be an alternating-current fan. In yet another embodiment, electron dispersing element 600 may not include fan 630. In such an embodiment, the flow of fluid may be generated through movement (for example, movement of a vehicle) or another source.

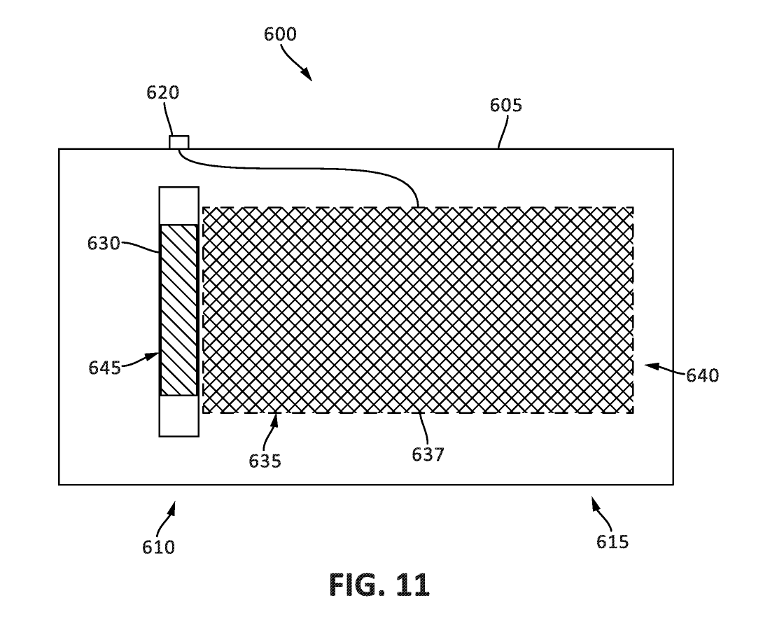

FIG. 11 illustrates the electronic dispersing element 600 having a conductive element 635 according to another embodiment. In the illustrated embodiment, the conductive element 635 includes a conductive material 637 (for example, a copper material, a copper mesh material, a steel material with a zinc coating, or any other conductive material) wrapped around a rigid base 640. In the illustrated embodiment, the conductive element 635 is positioned such that fluid flow from fan 630 flows across the surface area of the conductive material 637. In some embodiments, the conductive element 635 is positioned such that the rigid base 640 is located in a dead zone 645 of the fan 630. In such an embodiment, a substantial portion of the fluid flow from fan 630 may then flow across the surface area of the conductive material 637.

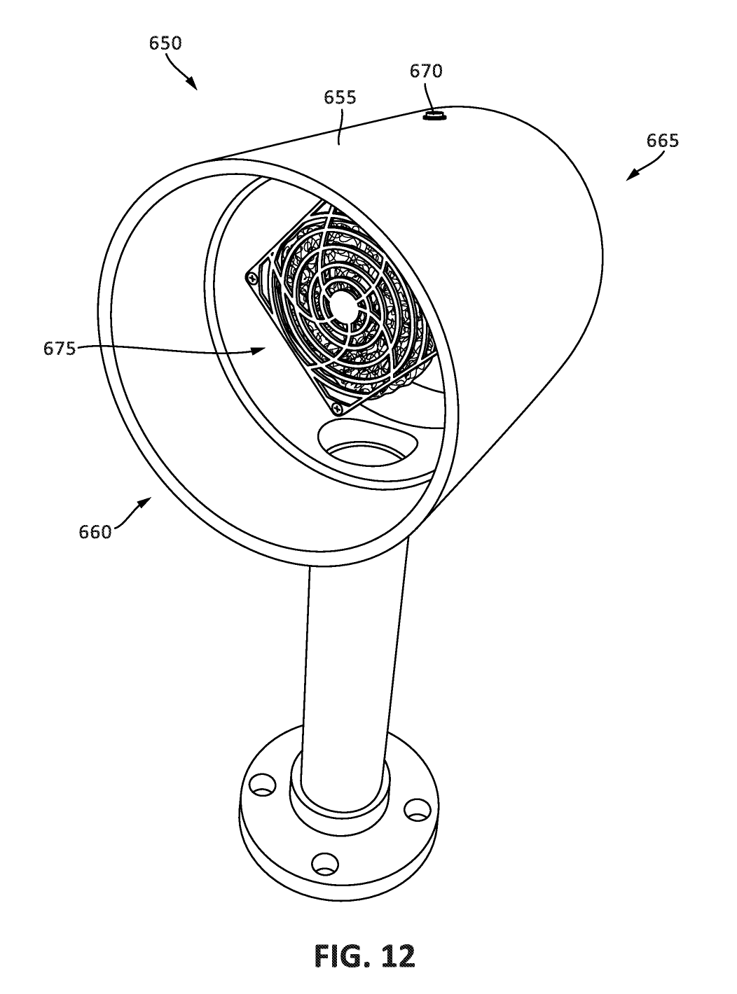

FIG. 12 illustrates an electron dispersing element 650 according to another embodiment. Similar to electron dispersing element 600, electron dispersing element 650 may be configured to provide an electrical ground, or voltage drop. The electron dispersing element 650 includes a housing 655 having a first end, or inlet, 660 and a second end, or outlet, 665. The housing 605 may be formed of a non-conductive material (for example, a plastic, including but not limited to, polyvinylchloride (PVC)). The electron dispersing element 650 may further include a connection 670. In the illustrated embodiment, connection 670 is located on an exterior of the housing 655. Connection 670 may be an electrical connection configured to receive electrical energy. For example, connection 670 may provide an electrical connection between conductive portion 210, 310, 410, and grounding element 215, 315, 415.

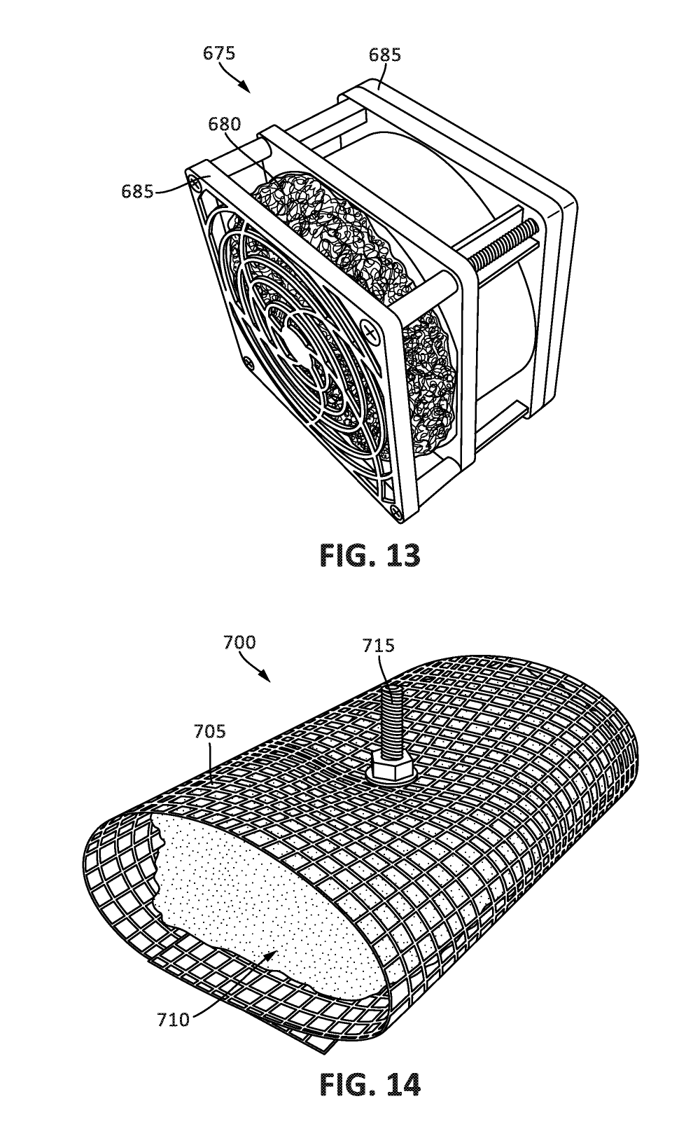

As further illustrated in FIG. 13, electron dispersing element 650 may further include a conductive unit 675 having a conductive element 680 and one or more fans 685. The conductive element 680 may be electrically coupled to connection 670. The conductive element 680 is configured to receive a charge from the connection 670 and dissipate the charge into the atmosphere. The conductive element 680 may be formed from a copper material, a copper mesh material, a steel material with a zinc coating, or any other conductive material. In the illustrated embodiment, conductive element 680 is positioned between fans 685.

The fans 685 are configured to provide a flow of fluid over the conductive element 680 (for example, in some embodiments, over the surface area of the mesh material of the conductive element 680). As fluid flows over the conductive element 680, the charge collected by the conductive element 680 may be dissipated into the atmosphere via the second end, or outlet, 665. In some embodiments, fans 685 is a low-voltage (for example, twelve volts) direct-current fan. In another embodiment, fan 685 may be an alternating-current fan. In yet another embodiment, electron dispersing element 650 may not include fan 685. In such an embodiment, the flow of fluid may be generated through movement (for example, movement of a vehicle) or another source.

FIG. 14 illustrates an electron dispersing element 700 according to another embodiment. Electron dispersing element 700 may be, or may be included in, grounding elements 215, 315, 415 and/or 540. Similar to electron dispersing elements 600, 650, electron dispersing element 700 may be configured to provide an electrical ground, or voltage drop. The electron dispersing element 700 may include a housing 705, a conductive element 710 within the housing 705, and a connection 715.

The conductive element 710 is electrically connected to the connection 715. Connection 715 may provide an electrical connection between a conductive portion and the conductive element 710 of the electron dispersing element 700. The conductive element 710 is configured to receive a charge from the connection 715 and dissipate the charge into the atmosphere. The conductive element 710 may be formed from a copper material, a copper mesh materials, a steel with zinc coating material, or any other conductive material.

In some embodiments, the system 100 includes a charge remover configured to remove a charge from a scrubbing device. In some embodiments, the charge remover is electron dispersing element 600, 650, 700 and/or a ground.

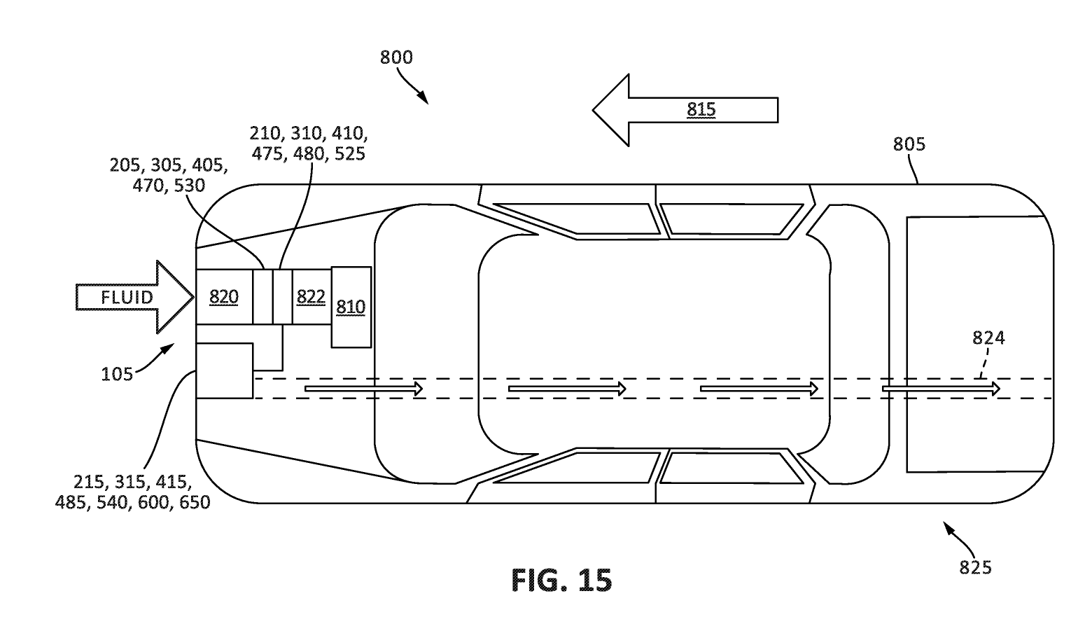

FIG. 15 illustrates a vehicle 800 according to some embodiments of the application. The vehicle 800 may be any motorized vehicle, including, but not limited to, a motorcycle, a scooter, a car, a truck, and a boat. The vehicle 800 includes a chassis 805, an engine 810 supported by the chassis 805, and an ionizer 105. The ionizer 105 may be any embodiment described above (for example, ionizer 200, 300, 400, 450, 500, 550) and may include any grounding element 215, 315, 415, 485, and/or 540 or any electron dispersing element 600, 650, 700.

The engine 810 may be any internal combustion engine (for example, a gasoline engine, a diesel engine, etc.) configured to provide power to the vehicle 800. In operation, as vehicle 800 moves in a first direction 815 a fluid (for example, air) enters an inlet 820 of ionizer 105. The fluid is ionized, or partially ionized, and provided to the engine 810, via outlet 822. Providing ionized, or partially ionized, fluid to the engine 810 may result in improved efficiency, improved emissions, higher horsepower, and increased torque, among other benefits.

The charge collected by a conducting portion is output to an electron dispersing element (for example, via a connection discussed above). As discussed above, the charge may then be dissipated into the atmosphere via outlet 824. In the illustrated embodiment, the outlet 824 may be provided under the vehicle 800 (for example, under the chassis 805) and may dissipate the charge into the atmosphere proximate a rear portion 825 of the vehicle 800. In some embodiments, the ionizer 105, including the electron dispersing element, may be electrically isolated from other components of the vehicle 800 (for example, the chassis 805 and engine 810). For example, the ionizer 105 may be coupled to the chassis 805 via electrically insulating materials.

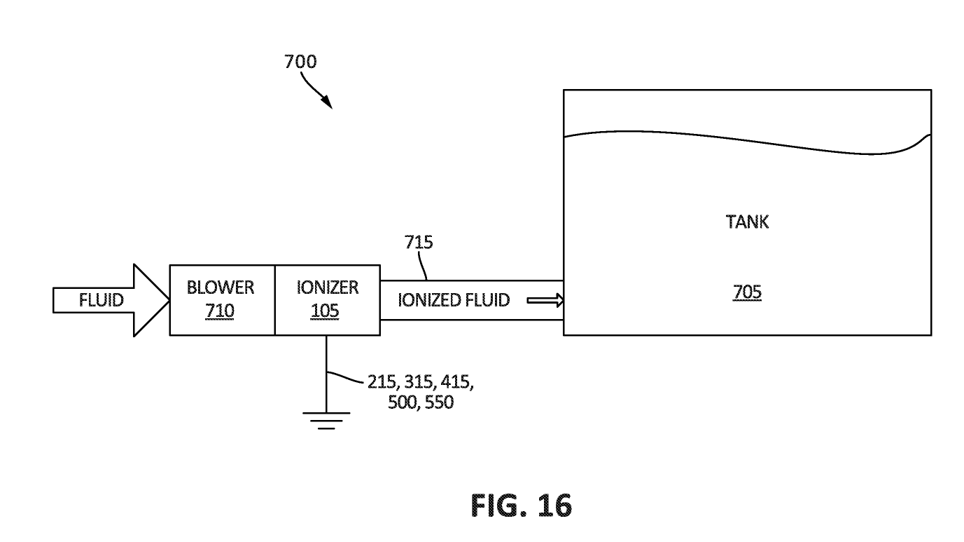

FIG. 16 illustrates a waste treatment, or biological oxidation, system 900 according to some embodiments of the application. The waste treatment system 900 includes a tank, or vessel, 905, a blower 910, a duct 915, and the ionizer 105. The ionizer 105 may be any embodiment described above (for example, ionizer 200, 300, 400, 450, 500, 550) and may include any grounding element 215, 315, 415, 485, and/or 540 or any electron dispersing element 600, 650.

The tank 905 is configured to hold a fluid (for example, water). The blower 910 is configured to provide a flow of a fluid (for example, air) to the ionizer 105. As discussed above, the ionizer 105 ionizes, or partially ionizes, the fluid from the blower 910 and provides the ionized, or partially ionized, fluid to the fluid within the tank 905 via the duct 915. Providing ionized, or partially ionized, fluid to the engine fluid held in the tank 905 may result in improved bacterial growth, and thus improved filtration, among other benefits.

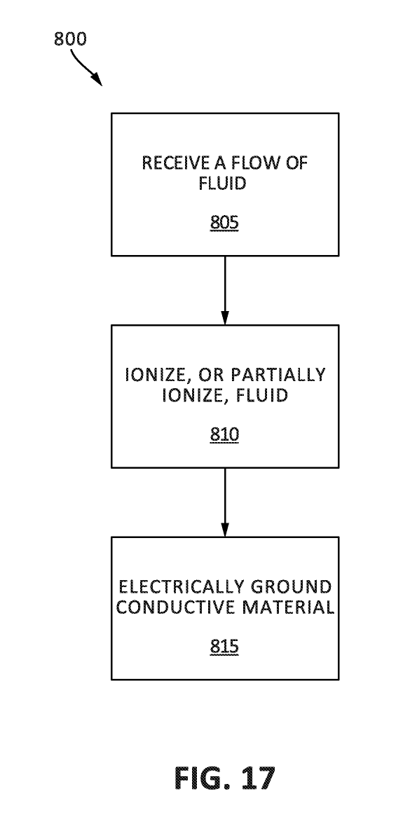

FIG. 17 is a flowchart illustrating a process or operation 1000 according to one embodiment. It should be understood that the order of the steps disclosed in process 1000 could vary. Furthermore, additional steps may be added to the sequence and not all of the steps may be required. Initially, a flow of fluid to be ionized is received across a surface area (for example surface areas 220, 320, 420, 490, 545) (block 1005). In some embodiments, as the fluid flows across the surface area, a friction is generated. This friction may result in static electricity being applied to the fluid. The fluid is ionized, or partially ionized (block 1010). In some embodiments, the fluid is ionized, or partially ionized, by applying the static electricity to the fluid, and collecting, via a conductive material (for example, conductive portions 210, 310, 410, 525), provided at the end of the flow of fluid, a removed electron from one or more molecules (for example, oxygen) of the fluid. A voltage drop is then provided (block 1015). In some embodiments, a grounding element (for example, grounding elements 215, 315, 415, 485, 540), or electron dispersing element (for example, electron dispersing elements 600, 650, 700, 800) is electrically connected to conductive material to provide a voltage drop, or ground the conductive material. The electrically connected grounding element removes, or drains, the electrons from the conductive material to prevent buildup of electrons.

In some embodiments, the ionized, or partially ionized, fluid may be provided to an animal (for example, a human). In such an embodiment, the ionized fluid may be provided to the animal via a medical device (for example, a respirator, a continuous positive airway pressure (CPAP) machine, etc.). Providing ionized, or partially ionized, fluid to the animal may result in an increase of oxygen received, and thus improved respiration, among other benefits.

Thus, the application provides, among other things, a system and method for ionizing, or partially ionizing, a fluid without the need for an external voltage source. Various features and advantages of the application are set forth in the following claims.

What is claimed is:

1. An ionization system configured to ionize a fluid, the system comprising:
a surface area configured to generate friction in response to a flow of the fluid across the surface area;
a conductive portion coupled to the surface area, the conductive portion is positioned proximate the flow of fluid; and
a voltage drop element coupled to the conductive portion, the voltage drop element configured to provide a voltage drop to the conductive portion.

2. The ionization system of claim 1, wherein the surface area conducts static electricity.

3. The ionization system of claim 1, wherein the voltage drop element is configured to drain one or more electrons collected by the conductive portion.

4. The ionization system of claim 1, wherein the voltage drop element includes at least one selected form the group consisting of plurality of conductive bristles and a conductive mesh.

5. The ionization system of claim 1, wherein the surface area is formed of a non-conductive material.

6. The ionization system of claim 1, wherein the surface area is formed of a plurality of nylon bristles.

7. The ionization system of claim 1, wherein the surface area is formed of a filter.

8. The ionization system of claim 7, wherein the filter includes a plurality of ridges.

9. The ionization system of claim 6, wherein the conductive portion is formed of a conductive grid.

10. The ionization system of claim 1, further comprising an output, wherein the output is configured to provide the ionized fluid to at least one selected from the group consisting of an engine, a water tank, and an animal.

11. The ionization system of claim 1, wherein the voltage drop element includes:
a housing having a first end and a second end;
an electrical input configured to receive a charge;
a conductive element located within the housing, the conductive element coupled to the electrical input; and
a fan located proximate the first end of the housing, the fan configured to provide a flow of fluid across the conductive element;
wherein the flow of fluid across the conductive element dissipate the charge into the atmosphere at the second end.

12. The electrical grounding apparatus of claim 11, wherein the conductive element includes at least one selected from the group consisting of a plurality of conductive bristles and a conductive mesh.

13. The electrical grounding apparatus of claim 11, wherein the charge is received from the conductive portion.

14. A system comprising:
a scrubbing device configured to remove a charge from an oxygen element of a flow of fluid; and
a charge remover configured to remove the charge from the scrubbing device.

15. A method of ionizing a fluid, the method comprising:
receiving a flow of fluid across a surface area to generate friction;
ionizing the fluid;
collecting, via a conductive material positioned at the end of the flow of fluid, a charge; and
providing a voltage drop.

16. The method of claim 15, wherein the friction produces static electricity.

17. The method of claim 15, wherein the surface area is formed of a non-conductive material.

18. The method of claim 15, further comprising providing an ionized fluid to at least one selected from the group consisting of an engine, a water tank, and a human.

19. The method of claim 15, wherein the step of ionizing the fluid includes partially ionizing the fluid.

20. A voltage drop apparatus, comprising:
a housing having a first end and a second end;
an electrical input configured to receive a charge;
a conductive element located within the housing, the conductive element coupled to the electrical input; and
a fan located proximate the first end of the housing, the fan configured to provide a flow of fluid across the conductive element;
wherein the flow of fluid across the conductive element dissipates the charge into the atmosphere at the second end.

21. The electrical grounding apparatus of claim 20, wherein the conductive element includes at least one selected from the group consisting of a plurality of conductive bristles and a conductive mesh.
